(19) United States
(12) Patent Application Publication
(10) Pub. No.: US 2003/0135992 A1
(43) Pub. Date: Jul. 24, 2003

(54) Back plate removing jig

(76) Inventor: Hao-Yun Ma, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/192,183

(22) Filed: Jul. 9, 2002

(30) Foreign Application Priority Data
Jan. 18, 2002 (TW) 91200432

(51) Int. Cl. B23P 19/00

(52) U.S. Cl. 29/762; 29/758

(57) ABSTRACT

A removing jig includes a shaft (10) having a first end (11) for abutting a motherboard (60) on which a back plate (50) is mounted and having a second end (12), a stationary hub (25) fixedly mounted on the shaft near the first end, a sliding hub (20) slidably mounted around the shaft between the second end and the stationary hub, and a plurality of claws (30) each including a finger (32) and a rib (33). Each finger has a free end (32a) having a catch (34), and a fixed end (32b) pivotably secured to the sliding hub. One end of each rib is pivotably secured to the stationary hub, and an opposite end is pivotably secured to the finger. When the sliding hub is moved toward the second end, the catches of the claws firmly clasp the back plate and pull the back plate away from the motherboard.

### BACKGROUND OF THE INVENTION

1. Field of the Invention

The present invention relates to removing jigs, and particularly to jigs for readily removing back plates from motherboards.

2. Related Art

Computer electronic devices such as central processing units (CPUs) frequently generate large amounts of heat, which can destabilize operation and cause damage. A heat sink placed in thermal contact with an electronic device transfers heat from the electronic device through conduction. Modern heat sinks are being made larger and larger. Therefore, a back plate is often attached on an underside of a motherboard below an electronic device mounted on the motherboard, for reinforcing the motherboard.

Conventionally, a plurality of posts is formed on a back plate. Free ends of the posts are secured to a motherboard by welding means or by interferential engagement. The back plate is thus mounted to an underside of the motherboard. Much force is required to remove the back plate from the motherboard. Oftentimes, removal is performed by hand or with a screwdriver. This is unduly laborious and troublesome. Furthermore, there is a high risk of damage to the back plate and components adjacent the back plate.

It is strongly desired to provide a jig for removing back plates from motherboards which can overcome the abovementioned problems.

### SUMMARY OF THE INVENTION

Accordingly, an object of the present invention is to provide a removing jig for readily removing a back plate from a motherboard.

To achieve the above-mentioned object, a removing jig in accordance with the present invention includes a shaft, a stationary hub, a sliding hub, and four claws. The shaft comprises a first end for abutting a motherboard on which a back plate is mounted, and a second end opposite to the first end. The stationary hub is fixedly mounted on the shaft near the first end. The sliding hub is slidably mounted around the shaft between the second end and the stationary hub. Each claw comprises a finger and a rib. The finger comprises a free end having a catch, and a fixed end pivotably secured to the sliding hub. One end of the rib is pivotably secured to the stationary hub, and an opposite end of the rib is pivotably secured to the finger. When the sliding hub is moved toward the second end of the shaft, the free ends of the fingers are moved toward the shaft. The catches of the claws firmly clasp the back plate. The free ends of the fingers are moved toward the second end, and the catches of the claws pull the back plate away from the motherboard.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded perspective view of a back plate removing jig in accordance with the present invention, together with a motherboard and a back plate;

FIG. 2 is similar to FIG. 1, but showing the jig fully assembled and engaged with the back plate;

FIG. 3 is a side elevational view of FIG. 2, showing the back plate and motherboard in cross-section; and

FIG. 4 is similar to FIG. 3, but showing the jig removing the back plate from the motherboard.

### DESCRIPTION OF THE PREFERRED EMBODIMENT

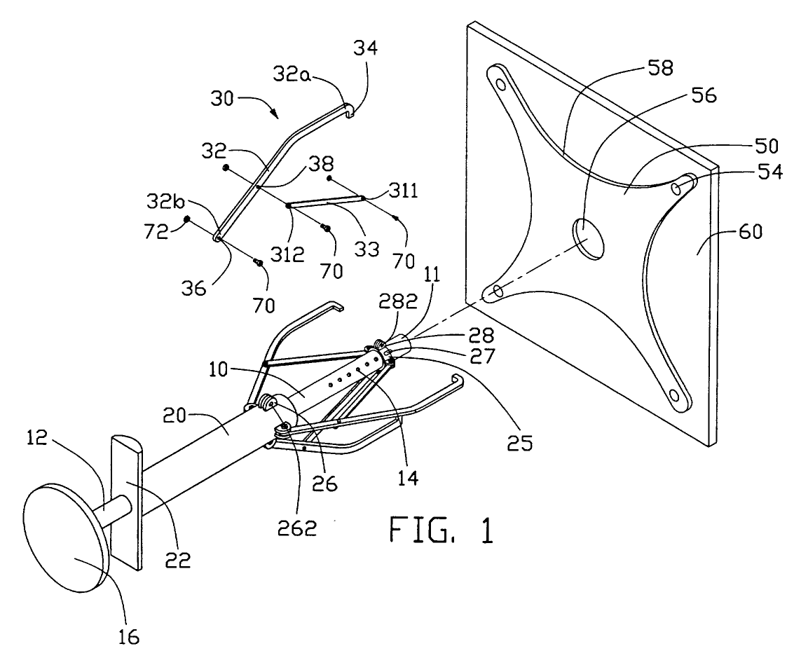

Referring to the attached drawings, FIG. 1 shows a jig in accordance with a preferred embodiment of the present invention together with a back plate 50 and a motherboard 60. The jig comprises a shaft 10, a T-shaped sliding hub 20, a stationary hub 25, and a plurality of claws 30. In the preferred embodiment, there are four claws 30.

The shaft 10 comprises a first end 11, and a second end 12 opposite to the first end 11. A plurality of retaining holes 14 is defined in the shaft 10 close to the first end 11. The retaining holes 14 are arranged in a line along a length of the shaft 10. A circular handle 16 is perpendicularly formed on the second end 12 of the shaft 10.

The sliding hub 20 is slidably mountable around the shaft 10 in the vicinity of the second end 12. A handlebar 22 is perpendicularly formed on one end of the sliding hub 20, adjacent the handle 16 of the shaft 10. Four pairs of first tabs 26 are formed on a circumferential surface of an opposite end of the sliding hub 20, opposing the handlebar 22. The four pairs of first tabs 26 are evenly spaced apart. A pair of aligned first through apertures 262 is respectively defined in each pair of first tabs 26. Four pairs of second tabs 28 are formed on a circumferential surface of the stationary hub 25. A pair of aligned second through apertures 282 is respectively defined in each pair of second tabs 28. A pin 27 is for fixedly attaching the stationary hub 25 to the shaft 10.

Each claw 30 comprises an arcuate finger 32 and a rib 33. The finger 32 comprises a free end 32a and an opposite fixed end 32b. The free end 32a is bent inwardly to form a catch 34. A first through hole 36 is defined in the fixed end 32b. A second through hole 38 is defined in the finger 32, between the fixed end 32b and a middle portion of the finger 32. A third through hole 311 is defined in one end of the rib 33. A fourth through hole 312 is defined in an opposite end of the rib 33. A plurality of screws 70 and nuts 72 are for securing the ribs 33 to the fingers 32, and for securing the claws 30 to the shaft 10.

In assembly, the sliding hub 20 is slidably mounted around the shaft 10 in the vicinity of the second end 12. The stationary hub 25 is fixedly attached to the shaft 10 by the pin 27 being selectively inserted into one of the retaining holes 14 of the shaft 10. One finger 32 is placed between one pair of first tabs 26, with the first through hole 36 of the fixed end 32b being aligned with the corresponding first through apertures 262. One screw 70 is extended through the first through apertures 262 and first through hole 36 to engage with one nut 72. The finger 32 is thus pivotably fixed to the sliding hub 20. In the same way, the other fingers 32 are pivotably fixed to the sliding hub 20. One rib 33 is then placed between one pair of second tabs 28 of the stationary hub 25, with the third through hole 311 of the rib 33 being aligned with the corresponding second through apertures 282. One screw 70 is then extended through the second through apertures 282 and third through hole 311 to engage with one nut 72. The rib 33 is thus pivotably fixed to the stationary hub 25. In the same way, the other ribs 33 are pivotably fixed to the stationary hub 25. One rib 33 is then placed next to a corresponding finger 32, with the fourth through hole 312 of the rib 33 being aligned with the second through hole 38 of the finger 32. One screw 70 is extended through the fourth through hole 312 and the second through hole 38 to engage with one nut 72. The rib 33 is thus pivotably fixed to the finger 32. In the same way, the other ribs 33 are pivotably fixed to the corresponding fingers 32. The jig is thus assembled.

The back plate 50 is generally cross-shaped, and has four concave surfaces 58 around a perimeter thereof. The back plate 50 also has four posts 54 formed at four extremities thereof respectively. A through opening 56 is defined in a central portion of the back plate 50. The back plate 50 is mounted on one side of the motherboard 60, with the posts 54 engaging with the motherboard 60.

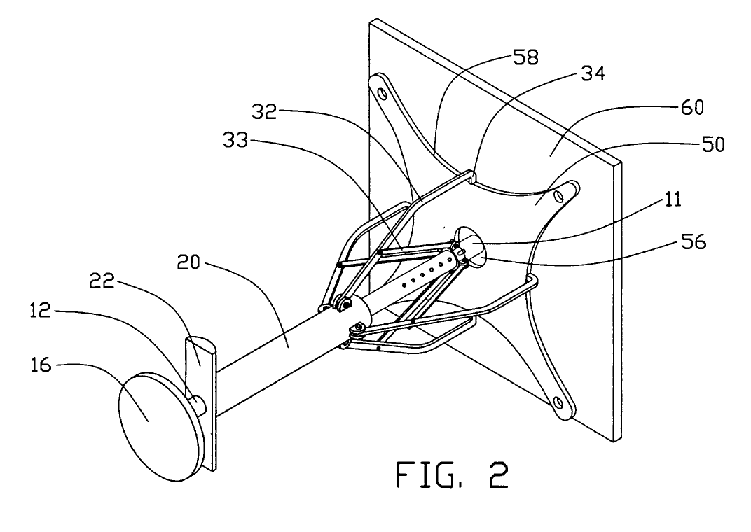

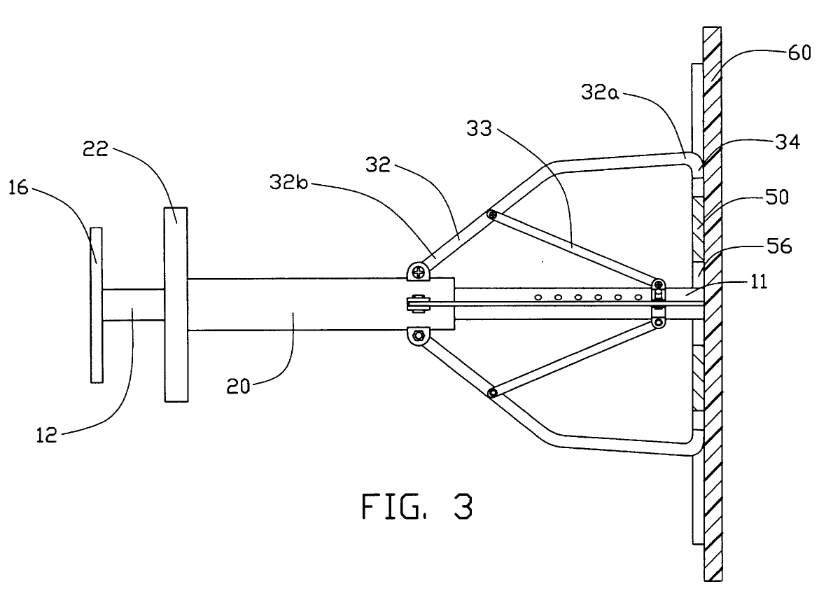

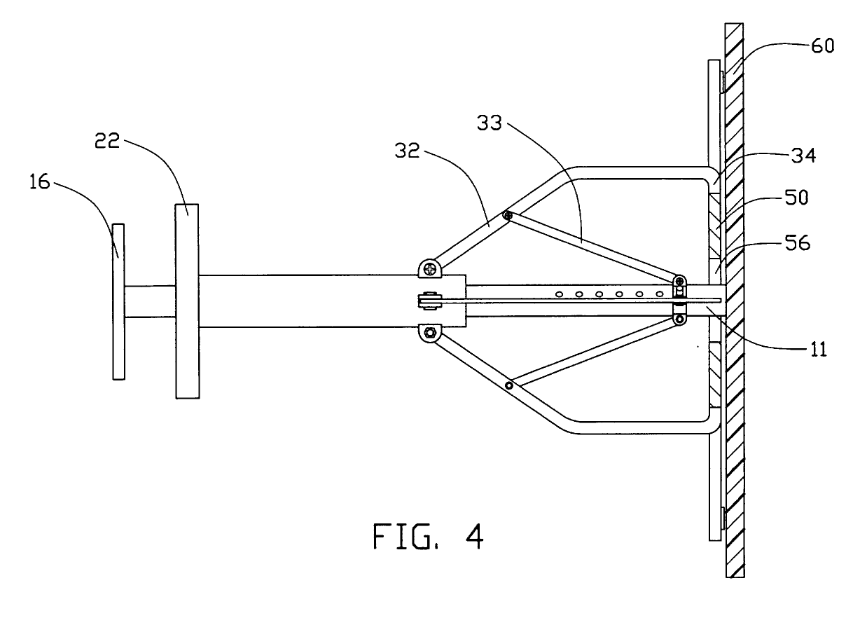

Referring to FIGS. 2-4, in operation of the jig, the first end 11 of the shaft 10 is extended through the opening 56 of the back plate 50 to abut the motherboard 60. The catches 34 of the claws 30 are engaged with the concave surfaces 58 of the back plate 50 respectively. The sliding hub 20 is moved toward the circular handle 16 of the shaft 10 by pulling the handlebar 22. The fixed ends 32b of the fingers 32 are pulled toward the circular handle 16. The ribs 33 are rotatingly pulled radially inwardly by the fingers 32 toward the shaft 10. An angle between each finger 32 and the shaft 10 is therefore reduced. The free ends 32a of the fingers 32 are therefore moved radially inwardly toward the shaft 10, thereby causing the catches 34 to firmly clasp the concave surfaces 58. The sliding hub 20 is continued to be pulled. The fingers 32 clasping the back plate 50 are pulled toward the circular handle 16. The back plate 50 is thus pulled away from the motherboard 60.

In the present invention, the position of the stationary hub 27 on the shaft 10 is adjustable. The pin 27 can be inserted into the appropriate retaining hole 14 according to a size of the back plate 50. For example, when a larger back plate 50 needs to be removed, the pin 27 is selectively inserted into a retaining hole 14 which is farther from the first end 11. This enables the claws 30 to fit the larger back plate 50.

It is understood that the invention may be embodied in other forms without departing from the spirit thereof. Thus, the present example and embodiment is to be considered in all respects as illustrative and not restrictive, and the invention is not to be limited to the details given herein.

1. A removing jig adapted for removing a back plate from a motherboard, the jig comprising:
a shaft having a first end adapted for abutting the motherboard, and a second end opposite to the first end;
a stationary hub fixedly mounted around the shaft near the first end;
a sliding hub slidably mounted around the shaft between the second end and the stationary hub; and
at least two claws each comprising a free end and a fixed end, the fixed end being pivotably secured to the sliding hub, wherein
when the sliding hub is moved toward the second end of the shaft, the free ends are moved toward the shaft and then toward the second end, whereby the at least two claws clasp the back plate and pull the back plate away from the motherboard.

2. The jig as claimed in claim 1, wherein each of the claws comprises a finger and a rib, the free end and the fixed end are respectively formed in the finger, one end of the rib is pivotably secured to the stationary hub, and an opposite end of the rib is pivotably secured to the finger.

3. The jig as claimed in claim 2, wherein each of the fingers has a catch formed on the free end thereof for clasping the back plate.

4. The jig as claimed in claim 1, wherein a plurality of retaining holes is defined in the shaft in the vicinity of the first end, and the stationary hub is secured on the shaft by a pin being selectively inserted into one of the retaining holes according to a size of the back plate.

5. The jig as claimed in claim 1, wherein the sliding hub is generally T-shaped, and has a handlebar formed on one end thereof adjacent the second end of the shaft.

6. The jig as claimed in claim 1, wherein a plurality of pairs of first tabs is formed on one end of the sliding hub adjacent the first end of the shaft, each of the first tabs defines a first through aperture, the fixed end of each of the fingers is disposed between a corresponding pair of first tabs, and a screw extends through the first through apertures and the fixed end and engages with a nut thereby pivotably securing the finger to the sliding hub.

7. The jig as claimed in claim 2, wherein a plurality of pairs of second tabs is formed on the stationary hub, each of the second tabs defines a second through aperture, said one end of each of the ribs is disposed between a corresponding pair of second tabs, and a screw extends through the second through apertures and said one end and engages with a nut thereby pivotably securing the rib to the stationary hub.

8. The jig as claimed in claim 1, wherein a circular handle is formed on the second end of the shaft.

9. A removing jig removing a back plate from a motherboard on which the back plate is fixed, the back plate comprising concave surfaces around a perimeter thereof and an opening defined in a center thereof, the jig comprising:
a shaft having a first end extending through the opening to abut the motherboard, and a second end opposite to the first end;
a stationary hub fixedly mounted on the shaft near the first end;
a sliding hub slidably mounted on the shaft between the second end and the stationary hub; and
a plurality of fingers and ribs, each of the fingers having a free end and a fixed end, the fixed end being pivotably fixed to the sliding hub, each of the ribs having one end pivotably fixed to the stationary hub and an opposite end pivotably fixed to a corresponding finger, wherein
when the sliding hub is moved toward the second end of the shaft, the free ends of the fingers are radially moved toward the shaft to clasp the back plate and pull the back plate away from the motherboard.

10. The jig as claimed in claim 9, wherein the shaft defines a plurality of retaining holes in the vicinity of the first end, and the stationary hub is fixed to the shaft by a pin being selectively inserted into one of the retaining holes according to a size of the back plate.

11. The jig as claimed in claim 9, wherein a plurality of pairs of first tabs is formed on one end of the sliding hub adjacent the first end of the shaft, each of the first tabs defines a first through aperture, the fixed end of each of the fingers is disposed between a corresponding pair of first tabs, and a screw extends through the first through apertures and the fixed end and engages with a nut thereby pivotably fixing the finger to the sliding hub.

12. The jig as claimed in claim 11, wherein the sliding hub is generally T-shaped, and has a handlebar formed on an opposite end thereof adjacent the second end of the shaft, the handlebar opposing the first tabs.

13. The jig as claimed in claim 11, wherein a plurality of pairs of second tabs is formed on the stationary hub, each of the second tabs defines a second through aperture, one end of each of the ribs is disposed between a corresponding pair of second tabs, and a screw extends through the second through apertures and said one end and engages with a nut thereby pivotably fixing the rib to the stationary hub.

14. The jig as claimed in claim 9, wherein a circular handle is formed on the second end of the shaft.

15. In combination,
a printed circuit board defining a plurality of holes;
a back plate closely positioned under the printed circuit board and defining a plurality of posts engaged within the corresponding holes, respectively, and an opening therein;
a tool including:
a shaft defining an upper end extending through said opening and abutting against an underside of said printed circuit board; and
at least two opposite grasping fingers each with one lower end up and down moveable along an axial direction of said shaft and an opposite upper end sweeping laterally and grasping a corresponding lateral edge of said back plate when said lower end is moved to a stop point relative to the shaft; wherein
a further downward movement of said lower end relative to the shaft results in significantly spacing said printed circuit board and said back plate away from each other, and associatively disengaging the posts from the corresponding holes.

16. The combination as claimed in claim 15, wherein the lower end of each of said fingers is pivotally fixed to a sleeve slidably axially moved along said shaft.

17. The combination as claimed in claim 15, wherein each of said fingers is pivotally moved about a pivot point between the lower end and the upper end.

18. The combination as claimed in claim 17, further including a rib with thereof an upper end pivotally fixed to the shaft and an opposite lower end pivotally fixed to said pivot point.

19. The combination as claimed in claim 15, wherein said stop point is for a downward movement of said lower end.

20. The combination as claimed in claim 19, wherein said upper end sweeps laterally and inwardly when said lower end is moved toward the stop point.

21. In combination,
a printed circuit board defining a plurality of holes;
a back plate closely positioned under the printed circuit board and defining a plurality of posts engaged within the corresponding holes, respectively, and an opening therein;
a tool including:
a shaft defining an upper end extending through said opening and abutting against an underside of said printed circuit board; and
at least two opposite pivotal grasping fingers each defining a pivot point between lower and upper ends thereof, said upper end sweeping laterally inwardly and grasping a corresponding lateral edge of said back plate when said lower end makes a relative outward movement about said pivot point; wherein
once the fingers grasp the back plate, a downward force is applied to the grasping fingers and results in significantly spacing said printed circuit board and said back plate away from each other, and associatively disengaging the posts from the corresponding holes.
